(19) United States
(12) Patent Application Publication
(10) Pub. No.: US 2001/0028237 A1
(43) Pub. Date: Oct. 11, 2001

(54) Perpetual motion energy of (GOD) on generating stations

(75) Inventor: Herbert R. Floyd, New York, NY (US)

Correspondence Address: HEARST MAGAZINE, P.O. BOX 286779, NEW YORK, NY, 10128, US

(73) Assignee: GM

(21) Appl. No.: 09/849,373

(22) Filed: May 4, 2001

Related U.S. Application Data
(63) Continuation-in-part of application No. 08/980,485, filed on Nov. 28, 1997, now abandoned.

(51) Int. Cl. H02J 7/00

(52) U.S. Cl. 320/107; 320/116

(57) ABSTRACT

Perpetual energy (PE) including two 22,000 V batteries, two DC-AC converters, and two DC-AC adaptors for connecting, therewith the converters, and the batteries, each battery is located in a conventional battery charger, such that both of the batteries define fully charged operating current thereby to charge one another until a double-bus, and double circuit breaker system prevent the batteries from overcharging. Two elevators to transmit restorable properties, so as to refill the batteries after one hundred years are provided, beneath, each charger.

### CROSS-REFERENCES TO RELATED APPLICATIONS

New CIP of Prior Ser. No. 08/980,485 on Feb. 28, 1997 now pending.

### BACKGROUND OF THE INVENTION

1. Field of the Invention

The present invention refers to energy and specifically to perpetual energy, i.e., regarding generating stations and substations including perpetually define bridges. While the bridges include PERPETUAL ENERGY (P.E.), their lights are to illuminate the bridges perpetually, thereby a system, as set forth in my prior UNITED STATES Patent Number:

Further, two several hundred ton batteries enclosed via conventional battery chargers, as set forth in my prior U.S. Patent, charges one another, so, as to, perpetually generate electric energy. This PE system will replace all heretofore electrical equipment, and can perpetually deliver electrical energy to associated systems, however for one hundred years.

X Department of Energy (General Provisions) (Parts 1000 1099), and XXXI Office of Environmental Quality with respect to the Department of Agriculture (Parts 3100 3199) by way of CFR, thus will regulate and control PERPETUAL MOTION ENERGY. P.M.E. (PERPETUAL MOTION ENERGY) systems will save thousands of dollars yearly, in maintenance cost for US organizations. While safety, and environmental concerns each of which is an important issue, a P.M.E. Electrically Powered Locomotive is to provide high Perpetual motion energy concerning its load. On earth, only one nation will be generating Giant Perpetual Motion Energy Systems; namely, THE UNITED STATES OF AMERICA.

2. Description of the Prior Art

PERPETUAL MOTION ENERGY is a revolutionary 21st Century reality, so that AMERICA do not have to depend on mechanical energy being changed into electrical energy by water, steam, gas and oil, as gasoline and petroleum. PERPETUAL ENERGY is a dominating power from (GOD), thus, presented to applicant, as a gift such that he will teach it under the provisions of the Code of Federal Regulations.

### SUMMARY OF THE INVENTION

Accordingly, one object of this present invention is to provide perpetual energy with respect to structures, such as Generating Stations, Bridges with Perpetual Battery Operated Phones, which turn on lights for illuminating these bridges, and Airports regarding perpetual battery operated equipment.

However, to accomplish the foregoing and other objects, a perpetual energy system for generating stations concerning (GOD) comprises: a charging system defining two batteries in such system, a first battery to fit a first charger, whereby a second battery is sized to befit a second charger, a first DC-AC converter and a first plug to befit a first receptacle on the first charger, a second DC-AC converter, and a second plug in a second receptacle upon the second charger and ways for the batteries to load each other, a first AC adaptor and a third plug to fit a first jack upon the first charger, so, the adaptor is to fit a socket via the second converter, the second charger comprises a way for outputting AC current for charging the first battery, a second AC adaptor and a fourth plug so as to fit a second jack about the second charger, as the adaptor is to befit a socket on the first converter, the first charger comprises ways to output current to charge the second battery, circuit breaker systems for interrupting the batteries regarding power via obstructing two circuits. The charging system has two pairs of LEDs to indicate low charge thereby, the breaker systems are to close the circuits. The batteries having a fifth to sixth LED to show full, whereby, the circuits comprise a way for being opened. The batteries connected via series, and ways thereby to operate, a seventh and eight LED have a way to emit light. The charging system is to connect to a generator whereby the batteries have ways to work as the generator is off. The batteries thereby have nonmetallic electric conductors, one solvent to dissolve and a ninth LED on power. The batteries have a transmitter, and ways to be refilled, whereby, the ninth LED is to emit light at one hundred years.

According to another merit regarding the new invention, a perpetual energy complex of GOD comprises charging systems which adds two batteries, such that the batteries are to fit in conventional chargers, DC-AC converters for converting DC current to alternating current regarding two converters, one first, and second AC adaptor including ways for charging the batteries by the converters, a generating station system for producing perpetual energy, illumination systems for thereby illuminating the batteries having spiraled light fixtures so as to enclose lamps, an authorized person defines a scooter, and a way for replacing the lamps, elevators for maintenance thereof receptacles and plugs, and a way for plugging in the converters. The batteries thereby, include ways to load one another, an adjacent bridge having self-chargeable batteries also. The bridge has bases whereby on each side of a river, the bases comprise the self-chargeable batteries, thereinto. The bridge having lamps and a way to thereby illuminate, the batteries have ways to illuminate the bridge. The batteries thereby, include structures, a main control center comprises feeders, branch circuits and a system ground. The lamps via the bridge comprises ways to be turned on by way of a timer, conventionally. The main control center, thereby, comprises branch control centers, and ways to send perpetual energy to various parts of a City.

### BRIEF DESCRIPTION OF THE DRAWINGS

Further objects and advantages given herewith about the present invention will be apparent regarding these drawings, and the preferred embodiments pertaining to the description, which should not be construed as limitations on the scope of the invention, but by the append claims;

FIG. 1 is a section view about two batteries concerning two battery chargers, which charge one another, perpetually;

FIG. 2 is a block diagram simplifying perpetual energy;

FIG. 3 is a section view defining a service entrance so as to replace flourescent lamps in a spiraled light fixture;

FIG. 4 is a perspective view via a bridge with bases on each side of a river, and has two self chargeable batteries;

FIG. 5 is a perspective view of a portion of the bridge adjacent the two battery chargers and their spiraled lights;

FIG. 6 is a rearward portion of one charger defining an electrical arrangement, so, as to transmit perpetual energy;

FIG. 7A is a diagram about a Double-bus, double circuit breaker system, comprising added assurance against shutdown;

FIG. 7B is a section view via a conventional generator;

### DESCRIPTION OF THE PREFERRED EMBODIMENTS

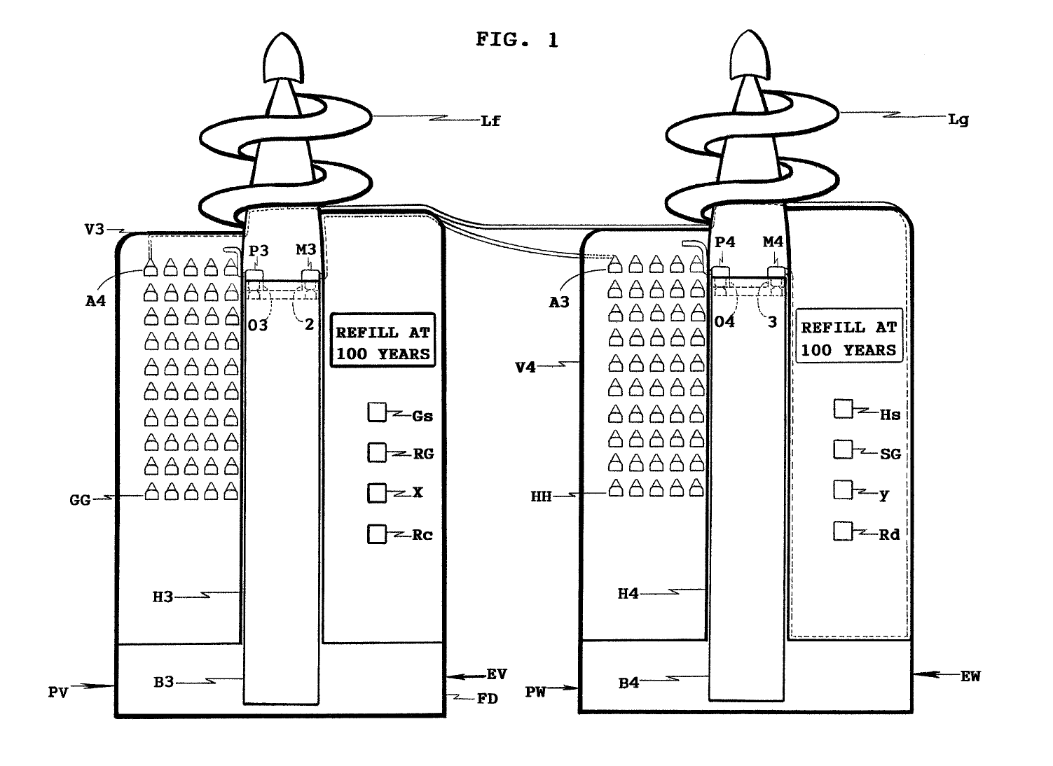

Referring to FIG. 1, two battery chargers H3-H4 include two batteries B3-B4, which charge one another as two LEDs Rc to Rd emit light on the chargers H3-H4.

The batteries B3 to B4 with respect to the conventional chargers H3-H4, however, are protected by reason of an inner circuit breaker so as to, automatically interrupt the power, when the current surpasses a set limitation concerning AMPS.

A plug P3 of a DC-AC converter V3 fits an output outlet 03 on the charger H3. A DC-AC converter V4 has a plug P4 in an output outlet 04 upon the charger H4. This system causes each 22,000 V battery to charge each other, as an AC adapter A3 fits a charger jack 2 by its plug M3 upon the charger H3. As the adapter part A3 plugs in the converter V4 the battery B4 outputs current that charges the battery B3. Now this is done, as an AC adapter A4 fits a charger jack 3 by a plug M4 on the charger H4, the adapter A4 plugs in the converter V3.

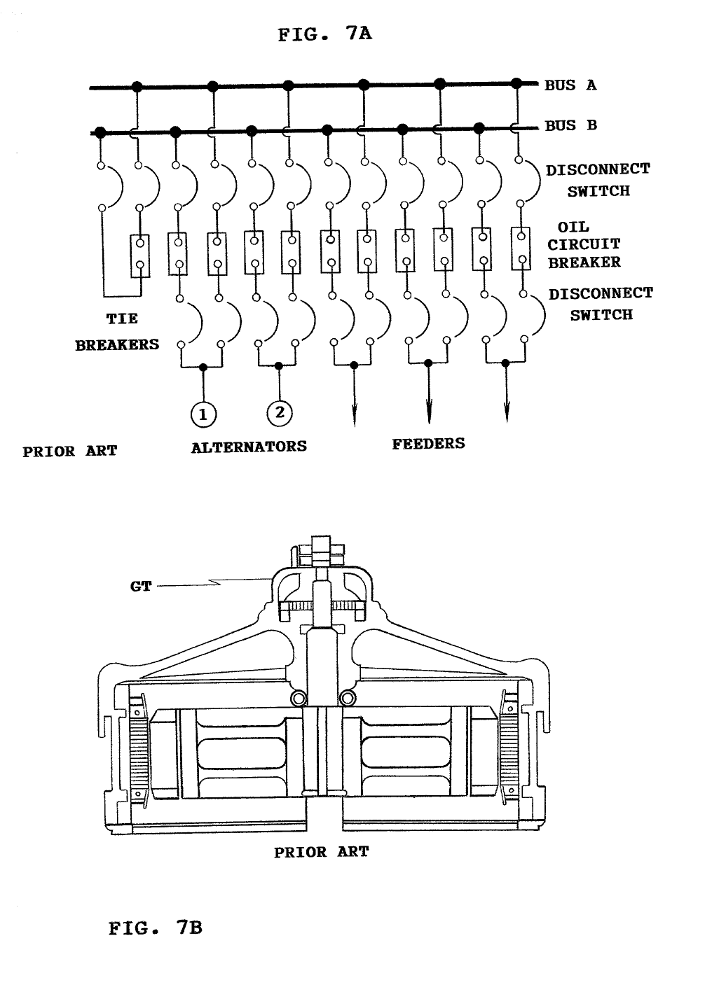

When the battery B3 is charging the battery B4, the out put outlet 03 on this charger H3 outputs 22,000 V DC current by which the converter V3 converts into alternating current. The current flows through this adapter A4, its lead, and the plug M4 via the charger jack 3. This charges the battery B4 whereby, the battery B4 is likewise charging the battery B3. As shown in FIG. 7A, a block diagram is provided for showing that a double-bus, double circuit-breaker Z1-Z2 prevents the batteries B3-B4 from overloading as the LEDs Rc-Rd glow when each battery B3-B4 charges one another. Two LEDs Gs-Hs glow as each battery B3-B4 endures a full charge. As the LEDs Gs to Hs, and two LEDs RG and SG emit light, each battery B3-B4 should be charged. The breakers Z1 and Z2 define disconnect switches and tie-bus breakers, such as to close two circuits C3-C4. Now, each battery B3-B4 starts charging one another. The batteries B3-B4 charge each other and when a full charge is, nigh, two LEDs X-y emit light. The batteries B3-B4 load one another to sustain a full charge, even as a generator GT in a generating station is turned off, as shown in FIG. 7B.

Now, maximum flexibility is provided by the double-bus, double-breaker system as shown in FIG. 7A. This arrangement is now provided, chiefly, in large generating stations where continuity of service is of prime importance. Consequently, both batteries B3-B4 charge one another, as a full charge is shown by the LEDs X-y, the double bus, double breaker system prevents damage to the central charging circuits C3-C4. Now this is accomplished only, via the breakers Z1-Z2 concerning the disconnecting switches so as to open the circuits C3-C4.

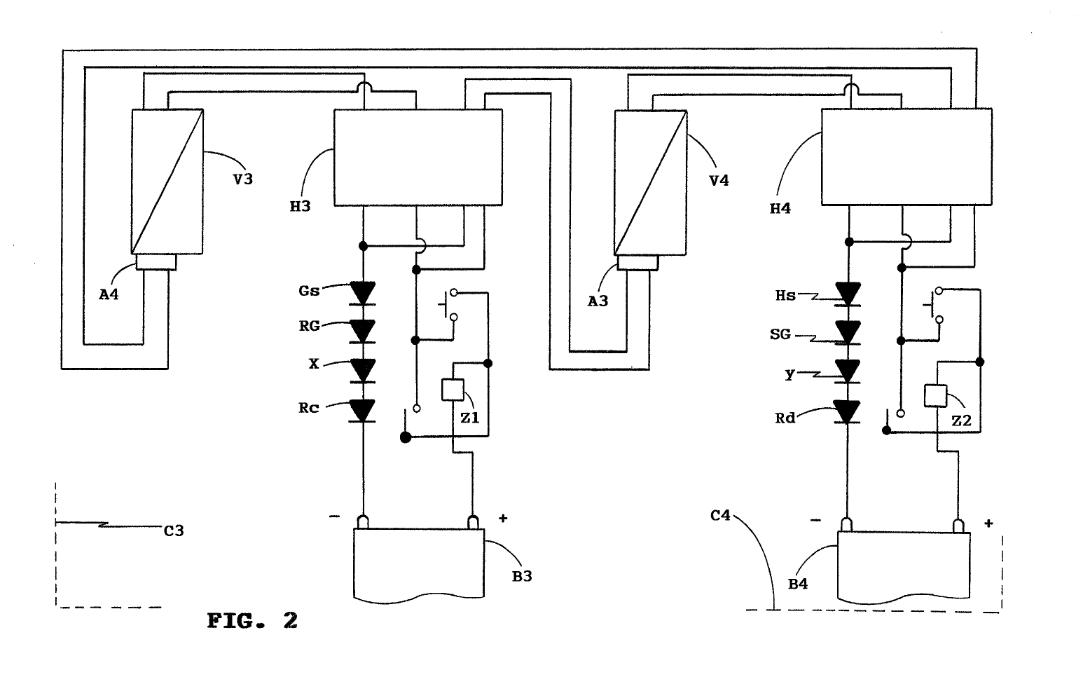

As shown in FIG. 2, the DC-AC converter V3 is connected to the charger H3, as the DC-AC converter V4 is connected to the charger H4, each battery B3-B4 charges one another as an end of the AC adapter A3 is connected to the charger H3. As the AC adapter part A3 is plugged into the converter V4, the battery B4 outputs current that charges the battery B3. Now this is done as a lead of the adapter A4 is connected to the charger H4, since its adapter portion A4 is plugged into the converter V3. The breakers Z1-Z2 are connected via an input terminal of the converters V3-V4. The LEDs Gs-SG emit light as each battery B3-B4 requires charging, all LEDs Rc-Rd, Gs, Hs, RG, SG, X, and y are connected via the other terminal of the converters V3-V4. The LEDs X-y emit light whenever each battery B3-B4 is fully charged by (PE) perpetual energy.

The PE system outputs current for charging each battery for one hundred years. As shown in FIGS. 1, 3, and 6, a LED 100 emits light via the battery charger H3 after one hundred years, and roughly, 6 months. While this is the life of the perpetual energy system, its producing mechanism regenerates the voltage in both batteries to a, fully, charged operating level as set forth above for one hundered years. E.g., this LED 100 emits light by an AC or DC current-limiting resistor to indicate that the batteries B3-B4 should be refilled.

Preferably, an elevator EV found beneath the charger H3 is provided with a system, such as to transmit a nonmetallic electric conductor Electrolyte in which current is, thereby, carried on an atom, as ion, or the movement of ions. As the atom ion carries a positive or negative electric charge, the charge is a result of having lost, or thereby, gained one or more electrons. Electrolyte is a substance, such that while dissolved in Sulphuric Acid becomes a fused ionic conductor.

Therefore, the batteries B3-B4 are refilled accordingly since another elevator EW consequently, is found beneath the charger H4, as set forth above with respect to modification. As a rule, two spiraled light fixtures Lf-Lg are defined for illuminating the chargers H3-H4 one half hour before sunset, since both structures are illuminated regarding skyscrapers.

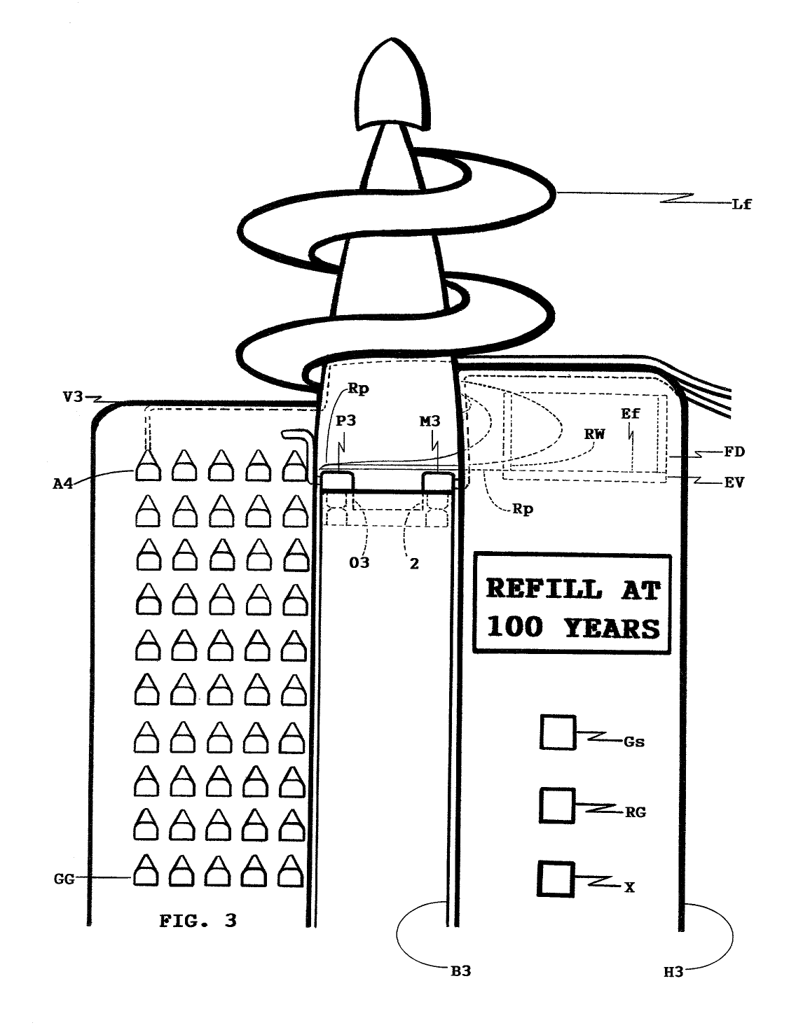

As shown in FIG. 3, the elevator EV comprises a door RW at its rearward portion, so that an authorized person having a scooter, and a lamp replacement timetable is to substitute the lamps in the fixture Lf. As a result, a scooter ramp Rp is adjacent to the elevator door RW, so that the scooter can be moved along a floor Ef about the elevator EV and onto the scooter ramp Rp, which leads into the light fixture Lf. The elevator EV and its door FD is adjacent to a roadway when it is upon ground lever, so vehicles can refill the battery B3.

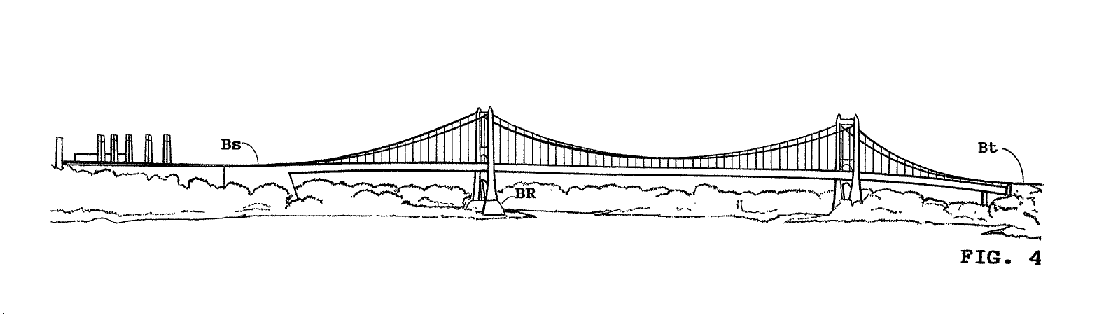

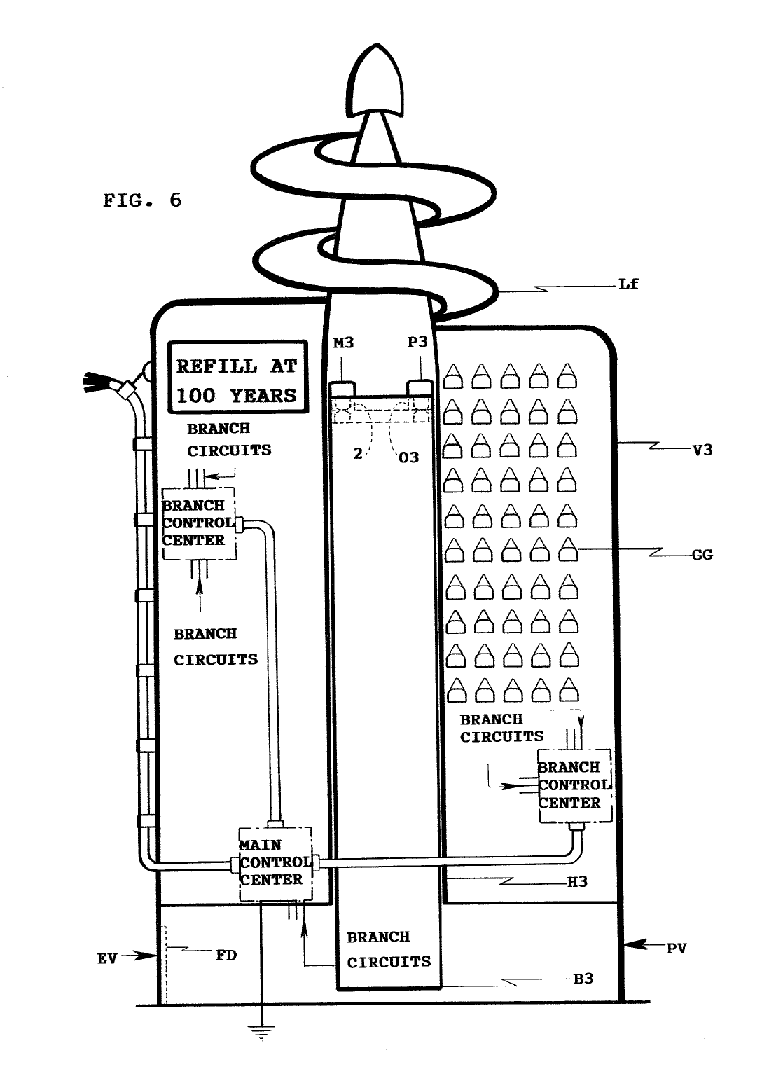

The converters V3-V4 have two elevators PV-PW, so as to service one hundred plugs GG in a face, and rearward portion via the converter V3 (FIG. 6). As fifty plugs HH are on the converter V4, its other fifty are not shown for transmitting perpetual energy to various portions of a City. As shown in FIG. 4, a bridge BR is provided with two bases Bs, and Bt by which two self chargeable batteries include a system such as to charge one another. This system is for illuminating many lamps concerning the bridge BR, since a timer is provided to conventionally, switch the lamps on, and off. The batteries and adjacent structures have main control centers comprising feeders, branch circuits and a system grown for transmitting perpetual energy to various locations of the bridge.

Lastly, a diagram is provided in FIG. 6 with respect to line installation, such that perpetual energy is transmitted from the generating station to many parts throughout a City.

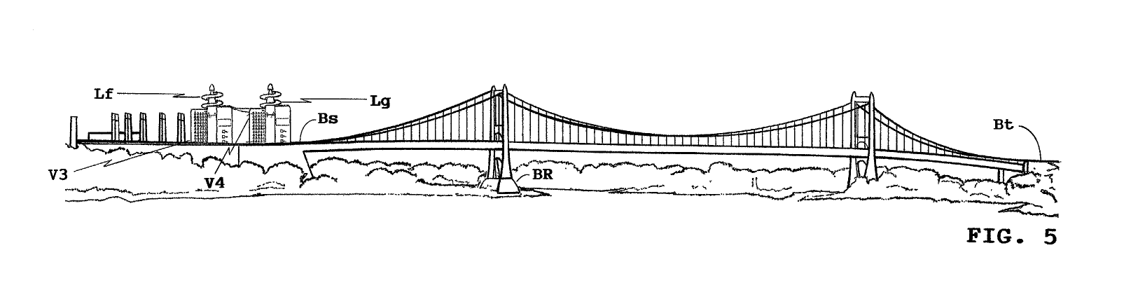

The generator GT, as shown in FIG. 7B does not comprise a conventional motor, seeing that this generator GT plugs in the converter V3 about the perpetual energy system shown via FIG. 1. Since the plugs GG, and HH are generator plugs, the energy system as shown in FIG. 1 is connected to two hundred generators. As shown in FIG. 5, the two converters V3 to V4 can be, clearly seen adjacent the bridge BR and its base Bs.

While the above description defines many specificities, these should not be construed as limitations on the scope of the invention, but rather, as an example about one preferred embodiment thereof. Many other variations and modifications are possible, for example, two additional receptacles can be installed concerning two batteries, such that two converters can plug in the two additional receptacles, so as to deliver additional energy perpetually to various locations of a City or, a housing development, perpetual battery operated phones without heretofore chargers, portable perpetual esculentors, so as to load and unload passengers at airports, perpetually defined portable systems for an A/C, electric-range, vehicle applications, hospitals, banks, trailer homes, ocean liners, jetliners, video equipment, musicale instruments, recorders, and systems about which perpetual energy is so needed. This witty invention should not be limited by the embodiment, but by the appended claims and their legal equivalents.

(GOD) and I claim:

1. A perpetual energy complex of GOD comprising:
charging means defining two batteries in a system;
a first battery to fit a first charger, whereby, a second battery is sized to fit a second charger;
a first DC to AC converter means, and a first plug to fit a first receptacle on said first charger;
a second DC to AC converter means on a second plug in a second receptacle upon said second charger, and means for said batteries to load each other;
a first AC adaptor and a third plug to fit a first jack upon said first charger, as said adaptor is to fit a socket via said second converter means, said second charger defines means for outputting AC current for charging said first battery;
a second AC adaptor and a fourth plug so as to fit a second jack about said second charger, as said adaptor is to fit a socket concerning said first converter means, said first charger having means to output current to charge said second battery;
circuit breaker means for excluding said batteries from power by means of obstructing two circuits.

2. A perpetual energy system as defined in claim 1, wherein said charging means has two pairs of LEDs to show low charge, said breaker means is for closing said circuits.

3. A perpetual energy system as defined in claim 1, wherein said batteries having a fifth to sixth LED to say full, said circuits include means for being opened.

4. A perpetual energy system as defined in claim 1, wherein said batteries connected via series, and means to operate, a seventh, and eighth LED have means to emit light.

5. A perpetual energy system as defined in claim 1, wherein said charging means is to connect to a generator, said batteries have means to work, as said generator is off.

6. A perpetual energy system as defined in claim 1, wherein said batteries thereby, have nonmetallic electric conductors, a solvent to dissolve, and a ninth LED on power.

7. A perpetual energy system as defined in claim 6, wherein said batteries have a transmitter and means to be refilled, as said ninth LED is to glow at one hundred years.

8. A perpetual energy complex of GOD comprising:
charging means having two batteries such that said batteries are to fit in conventional chargers;
DC to AC converter means for converting DC current to alternating current regarding two converters;
a first, and second AC adaptor including means for charging said batteries by said converter means;
generating stations means for generating perpetual energy;
illumination means for illuminating said batteries having spiraled light fixtures, so as to enclose lamps, an authorized person comprises a scooter, and means for replacing said lamps;
elevator means for inspection via receptacles, and plugs, and means to plug in said converters;

9. A perpetual energy system as defined in claim 8, wherein said batteries include means to load one another, an adjacent bridge includes self chargeable batteries, also.

10. A perpetual energy system as defined in claim 9, wherein said bridge having bases on each side of a river, said bases comprise said self chargeable batteries, therein.

11. A perpetual energy system as defined in claim 9, wherein said bridge having lamps and means to illuminate, said batteries include means to illuminate said bridge.

12. A perpetual energy system as defined in claim 8, wherein said batteries include structures, a main control center defines feeders, branch circuits and a system ground.

13. A perpetual energy system as defined in claim 11, wherein said lamps via said bridge comprises means to be turned on by means of a timer, conventionally.

14. A perpetual energy system as defined in claim 12, wherein said main center has branch control centers, and means to send perpetual energy to various parts of a city.
